(19) United States
(12) Patent Application Publication
(10) Pub. No.: US 2007/0133991 A1
(43) Pub. Date: Jun. 14, 2007

(54) Encoder/decoder for OCDMA and method thereof

(75) Inventors: Won Kyoung Lee, Daejeon-city (KR); Heuk Park, Daejeon-city (KR); Kwang Joon Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/606,670

(22) Filed: Nov. 29, 2006

(30) Foreign Application Priority Data
Dec. 9, 2005 (KR) 10-2005-0121028
Mar. 9, 2006 (KR) 10-2006-0022258

(51) Int. Cl. H04J 14/00

(52) U.S. Cl. 398/78

(57) ABSTRACT

Provided are an encoder and/or decoder for an OCDMA (optical code division multiple access) and a method thereof. The encoder and/or decoder includes: a demultiplexer outputting multi-wavelength optical signals through paths varying with a wavelength using a plurality of first fused couplers having different coupling coefficients; and a multiplexer selecting the signals of predetermined wavelengths out of output signals from the demultiplexer using a plurality of second fused couplers symmetric to the plurality of first fused couplers and generating a PN code corresponding to the selected wavelengths.

### CROSS-REFERENCE TO RELATED PATENT APPLICATION

This application claims the benefit of Korean Patent Application Nos. 10-2005-0121028, filed on Dec. 9, 2005 and 10-2006-0022258, filed on March 9 in the Korean Intellectual Property Office, the disclosures of which are incorporated herein in their entirety by reference.

### BACKGROUND OF THE INVENTION

1. Field of the Invention

The present invention relates to an encoder and/or decoder for an optical code division multiple access (OCDMA) and a method thereof, and more particularly, to an encoder and/or decoder using fused fiber-optic couplers and a method thereof.

2. Description of the Related Art

In general, gratings are carved in optical fibers for optical CDMA encoders and/or decoders. There are fiber bragg grating arrays in which several gratings are carved in optical fibers and chirped fiber bragg gratings.

As shown in FIG. 1A, such a fiber bragg grating array includes a serial array in which several fiber bragg gratings having different reflection wavelengths are sequentially carved in an optical fiber and a parallel array in which several fiber bragg gratings are carved in several optical fibers one by one.

In the serial array of fiber bragg gratings, a number of fiber bragg gratings must be increased with an increase in a number of channels. Thus, a length of an optical fiber is lengthened, and thus a transmission rate or the number of channels is limited by a delay.

In the parallel array of fiber bragg gratings, a fiber bragg grating is carved in a fiber. Thus, a transmission rate or the number of channels is not limited by a delay. However, a number of strands of the fiber are increased with the increase in the number of channels. As a result, a bulk of the fiber is increased.

Also, input light must be split in the parallel array of fiber bragg gratings and signals having passed through a parallel array of fiber bragg gratings must be integrated into one. Thus, insertion losses of a splitter and a coupler occur.

A chirped fiber bragg grating as shown in FIG. 1 B can realize several channels and thus is small. However, since reflectance at both ends of a reflection spectrum of the chirped fiber bragg grating is low, a loss difference between channels is great.

### SUMMARY OF THE INVENTION

The present invention provides an encoder and/or decoder for an OCDMA realized using fused fiber-optic couplers and a method thereof.

According to an aspect of the present invention, there is provided an encoder and/or decoder for an OCDMA (optical code division multiple access), including: a demultiplexer outputting multi-wavelength optical signals through paths varying with a wavelength using a plurality of first fused couplers having different coupling coefficients; and a multiplexer selecting signals of predetermined wavelengths out of output signals from the demultiplexer and generating a PN code corresponding to the selected wavelengths using a plurality of second fused couplers symmetric to the plurality of first fused couplers.

According to another aspect of the present invention, there is provided an encoding and/or decoding method for an OCDMA, including: outputting multi-wavelength optical signals through paths varying with a wavelength using a plurality of first fused couplers having different coupling coefficients; and selecting predetermined wavelengths out of output signals and generating a PN code corresponding to the selected wavelengths using a plurality of second fused couplers symmetric to the plurality of first fused couplers.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are views illustrating a structure of an encoder and/or decoder for an OCDMA using optical fiber bragg gratings;

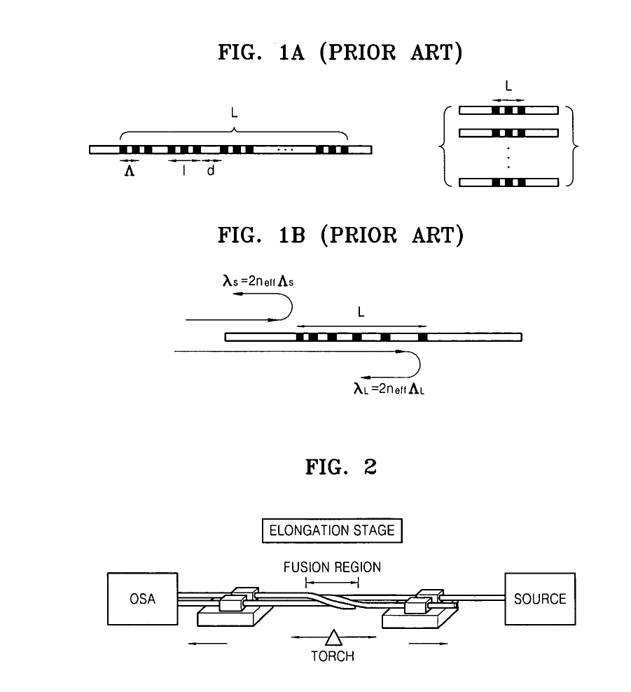

FIG. 2 is a view illustrating a process of manufacturing a fused coupler constituting an encoder and/or decoder for an OCDMA according to the present invention;

FIG. 3 is a view illustrating a modeling structure for computing a transmission characteristic of the fused coupler constituting the encoder and/or decoder for the OCDMA according to the present invention;

FIGS. 4A and 4B are views illustrating a structure of a 16-channel demultiplexer based on the fused coupler constituting the encoder and/or decoder for the OCDMA according to the present invention;

FIG. 5 is a graph illustrating an output spectrum of the 16-channel demultiplexer based on the fused couplers constituting the encoder and/or decoder for the OCMDA according to the present invention;

FIG. 6 is a graph illustrating a power difference with respect to each channel of a light source;

FIGS. 7A and 7B are views illustrating a structure of a flattening filter compensating for a non-uniform spectrum of a light source using fused couplers according to the present invention;

FIG. 8 is a graph illustrating a transmission spectrum of a flattening filter compensating for a non-uniform spectrum of a light source using fused couplers according to the present invention;

FIG. 9 is a graph illustrating a transmission spectrum of a structure into which a flattening filter compensating for a non-uniform spectrum of a light source using fused coupler according to the present invention and a 16-channel demultiplexer are integrated;

FIG. 10 is a view illustrating a structure of an encoder and/or decoder for an OCDMA according to the present invention in which the function of compensating for a non-uniform spectrum of a light source is added;

FIGS. 11A through 11H are graphs illustrating spectrums of PN codes realized in a structure of an encoder and/or decoder for an OCDMA according to the present invention;

FIG. 12 is a view illustrating modified PN codes having a code length of 15; and

FIG. 13 is a flowchart of a process of operating an encoder and/or decoder for an OCDMA according to the present invention.

### DETAILED DESCRIPTION OF THE INVENTION

Hereinafter, preferred embodiments of the present invention will be described with reference to the attached drawings.

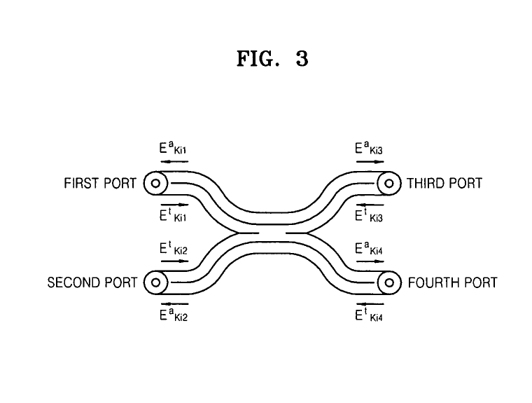

FIG. 2 is a view illustrating a process of manufacturing a fused coupler constituting an encoder and/or decoder for an OCDMA according to the present invention.

Coatings of two strands of optical fibers are stripped off and then twisted two times so as to fix both ends.

If a portion of the optical fiber of which coating has been stripped off and twisted two times is heated and tensed, a fusion region or an integrated portion is generated. Two modes independently advancing toward cores of two optical fibers interfere with each other in the fusion region and advance with interchanging energy.

The two strands of the optical fiber are heated to be lengthened and attached to each other to form the fusion region. Thus, a reflection does not occur with optical fibers positioned in the same direction. As a result, an additional loss of a fused coupler is very low.

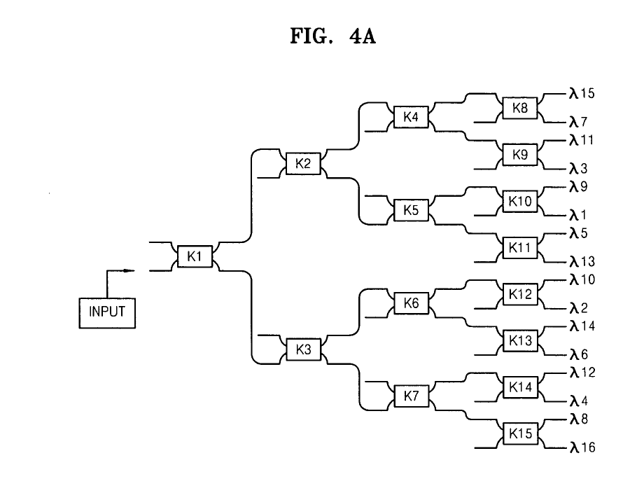

FIG. 3 is a view illustrating a modeling structure for computing a transmission characteristic of a fused coupler constituting an encoder and/or decoder for an OCDMA according to the present invention.

Electromagnetic fields of input and output ports of a fusion coupler having a coupling coefficient Ki are as shown in FIG. 3.

The relationship among the electromagnetic fields is expressed as in Equation 1 below. Here, a subscript of an electromagnetic field E denotes an orientation (position) of the electromagnetic field E, a superscript denotes an output signal from each point of the fusion coupler, and t superscript denotes an input signal to the fusion coupler.
E^{a}_{Ki1}=j\sqrt{KᵢE^{t}_{Ki4}} E^{a}_{Ki2}=j\sqrt{1−KᵢE^{t}_{Ki4}}
E^{a}_{Ki3}=j\sqrt{KᵢE^{t}_{Ki2}} E^{a}_{Ki4}=j\sqrt{1−KᵢE^{t}_{KI4}} (1)
wherein Ki denotes a coupling coefficient, E^{a}_{Ki1} denotes an electromagnetic field of E^{t}_{Ki4} outputted to a first port, E^{a}_{Ki2} denotes an electromagnetic field of E^{t}_{Ki4} outputted to a second port, E^{a}_{Ki3} denotes an electromagnetic field of E^{t}_{Ki2} outputted to a third port, and E^{a}_{Ki4} denotes an electromagnetic field of E^{t}_{Ki2} outputted to a fourth port.

An encoder and/or decoder for an OCDMA suggested in the present invention include a demultiplexer to which a plurality of fused couplers are connected.

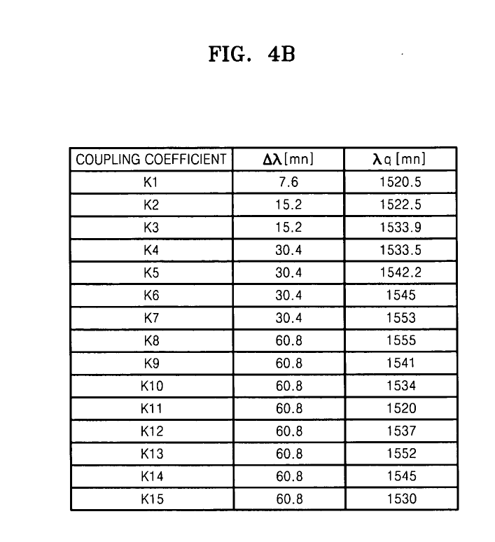

FIGS. 4A and 4B are views illustrating a structure of a 16-channel demultiplexer based on the fused coupler constituting the encoder and/or decoder for the OCDMA according to the present invention. 15 fused couplers are designed so as to have different coupling coefficients and coupling coefficients determined by central wavelengths and wavelength periods of the 15 fused couplers. A transmittance of each of the 15 fused couplers shown in FIG. 4A is expressed as in Equation 2 below.

$${T}_{K 13} = j \sqrt{K 1} = \frac{1}{2} [ 1 + sin ( \frac{2 π}{Δ {λ}_{1}} ( λ - {λ}_{q 1} ) + π ] \\ {T}_{K 14} = j \sqrt{1 - K 1} = \frac{1}{2} [ 1 + sin ( \frac{2 π}{Δ {λ}_{1}} ( λ - {λ}_{q 1} ) ] \\ \begin{matrix}{E}_{23}^{a} = {T}_{K 13} \cdot {T}_{K 23} \cdot {E}_{12}^{t} & {E}_{24}^{a} = {T}_{K 13} \cdot {T}_{K 24} \cdot {E}_{12}^{t} \\ {E}_{33}^{a} = {T}_{K 14} \cdot {T}_{K 33} \cdot {E}_{12}^{t} & {E}_{34}^{a} = {T}_{K 14} \cdot {T}_{k 34} \cdot {E}_{12}^{t} \\ {E}_{43}^{a} = {T}_{K 13} \cdot {T}_{K 23} \cdot {T}_{K 43} \cdot {E}_{12}^{t} & {E}_{44}^{a} = {T}_{K 13} \cdot {T}_{K 23} \cdot {T}_{K 44} \cdot {E}_{12}^{t}\end{matrix} \\ \begin{matrix}{E}_{53}^{a} = {T}_{K 13} \cdot {T}_{K 24} \cdot {T}_{K 53} \cdot {E}_{12}^{t} & {E}_{54}^{a} = {T}_{K 13} \cdot {T}_{K 24} \cdot {T}_{K 54} \cdot {E}_{12}^{t} \\ {E}_{63}^{a} = {T}_{K 14} \cdot {T}_{K 33} \cdot {T}_{K 63} \cdot {E}_{12}^{t} & {E}_{64}^{a} = {T}_{K 14} \cdot {T}_{K 33} \cdot {T}_{K 64} \cdot {E}_{12}^{t} \\ {E}_{73}^{a} = {T}_{K 14} \cdot {T}_{K 34} \cdot {T}_{K 73} \cdot {E}_{12}^{t} & {E}_{74}^{a} = {T}_{K 14} \cdot {T}_{K 34} \cdot {T}_{K 74} \cdot {E}_{12}^{t}\end{matrix} \\ \begin{matrix}{E}_{83}^{a} = {T}_{K 13} \cdot {T}_{K 24} \cdot {T}_{K 43} \cdot {T}_{K 43} \cdot {E}_{12}^{t} & {E}_{84}^{a} = {T}_{K 13} \cdot {T}_{K 23} \cdot {T}_{K 43} \cdot {T}_{K 84} \cdot {E}_{12}^{t} \\ {E}_{93}^{a} = {T}_{K 13} \cdot {T}_{K 33} \cdot {T}_{K 44} \cdot {T}_{K 93} \cdot {E}_{12}^{t} & {E}_{94}^{a} = {T}_{K 13} \cdot {T}_{K 33} \cdot {T}_{K 44} \cdot {T}_{K 94} \cdot {E}_{12}^{t} \\ {E}_{103}^{a} = {T}_{K 13} \cdot {T}_{K 24} \cdot {T}_{K 53} \cdot {T}_{K 103} \cdot {E}_{12}^{t} & {E}_{104}^{a} = {T}_{K 13} \cdot {T}_{K 24} \cdot {T}_{K 53} \cdot {T}_{K 104} \cdot {E}_{12}^{t}\end{matrix} \\ \begin{matrix}{E}_{113}^{a} = {T}_{K 13} \cdot {T}_{K 24} \cdot {T}_{K 54} \cdot {T}_{K 113} \cdot {E}_{12}^{t} & {E}_{114}^{a} = {T}_{K 13} \cdot {T}_{K 24} \cdot {T}_{K 54} \cdot {T}_{K 114} \cdot {E}_{12}^{t} \\ {E}_{123}^{a} = {T}_{K 14} \cdot {T}_{K 33} \cdot {T}_{K 63} \cdot {T}_{K 123} \cdot {E}_{12}^{t} & {E}_{124}^{a} = {T}_{K 14} \cdot {T}_{K 33} \cdot {T}_{K 63} \cdot {T}_{K 124} \cdot {E}_{12}^{t} \\ {E}_{133}^{a} = {T}_{K 14} \cdot {T}_{K 33} \cdot {T}_{K 64} \cdot {T}_{K 133} \cdot {E}_{12}^{t} & {E}_{134}^{a} = {T}_{K 14} \cdot {T}_{K 33} \cdot {T}_{K 64} \cdot {T}_{K 134} \cdot {E}_{12}^{t}\end{matrix} \\ \begin{matrix}{E}_{143}^{a} = {T}_{K 14} \cdot {T}_{K 34} \cdot {T}_{K 73} \cdot {T}_{K 143} \cdot {E}_{12}^{t} & {E}_{144}^{a} = {T}_{K 14} \cdot {T}_{K 34} \cdot {T}_{K 73} \cdot {T}_{K 144} \cdot {E}_{12}^{t} \\ {E}_{153}^{a} = {T}_{K 14} \cdot {T}_{K 34} \cdot {T}_{K 74} \cdot {T}_{K 153} \cdot {E}_{12}^{t} & {E}_{154}^{a} = {T}_{K 14} \cdot {T}_{K 34} \cdot {T}_{K 74} \cdot {T}_{K 154} \cdot {E}_{12}^{t}\end{matrix} \qquad ( 2 )$$

wherein T_{K13} denotes a transmittance of E^{a}ₖ₁₃ outputted from a fused coupler having a coupling coefficient K1 to the third port, and T_{K14} denotes a transmittance of E^{a}ₖ₁₄ outputted from the fused coupler having the coupling coefficient K1 to a lower port.

As a result of a computation of a whole transmission spectrum through Equation 2, conditions of a demultiplexer having 16 channels at uniform distances are shown in FIG. 4B.

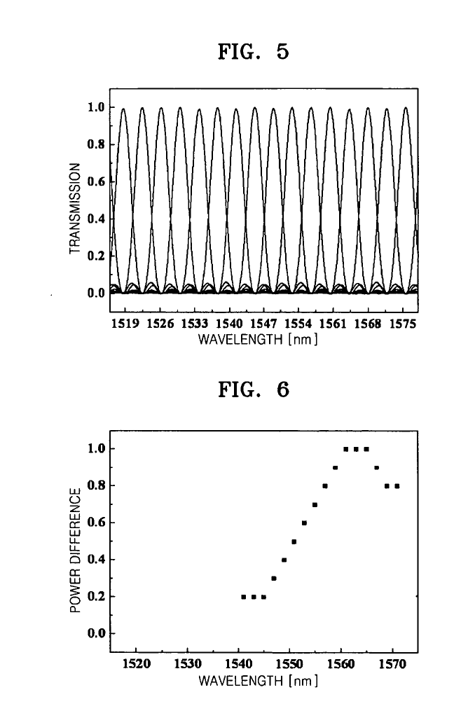

FIG. 5 is a graph illustrating an output spectrum of a 16-channel demultiplexer based on the fused coupler constituting the encoder and/or decoder for the OCMDA according to the present invention.

A super luminescent emitting diode (SLED) as a wide band light source is mainly used as a light source of an optical CDMA to reduce cost.

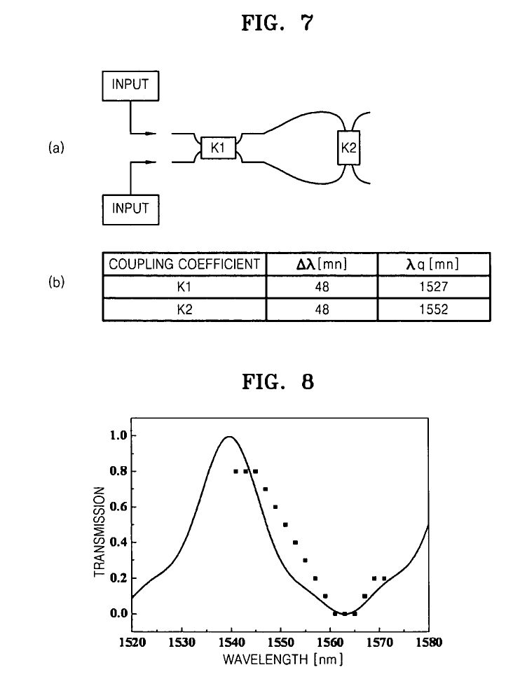

However, in the case of the SLED, a power difference is great in each channel like an output spectrum shown in FIG. 6. Thus, the SLED cannot accommodate many channels. Thus, in the present invention, a flattening filter is constituted using two fused couplers to compensate for a non-uniform spectrum of a light source.

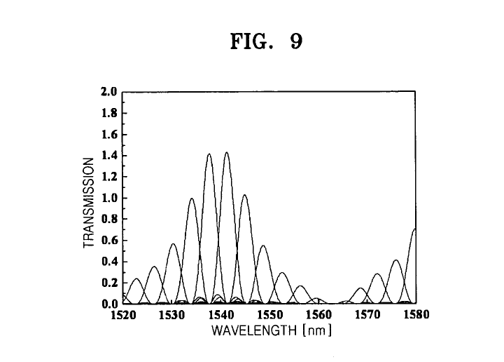

FIGS. 7A and 7B are views illustrating a structure of a flattening filter compensating for a non-uniform spectrum of a light source using a fused coupler according to the present invention.

Central wavelengths and wavelength periods of the fusion couplers are shown in FIG. 7B. Two fused couplers are connected to each other in a ring shape, and two ports of a first fused coupler are used as input and output ports.

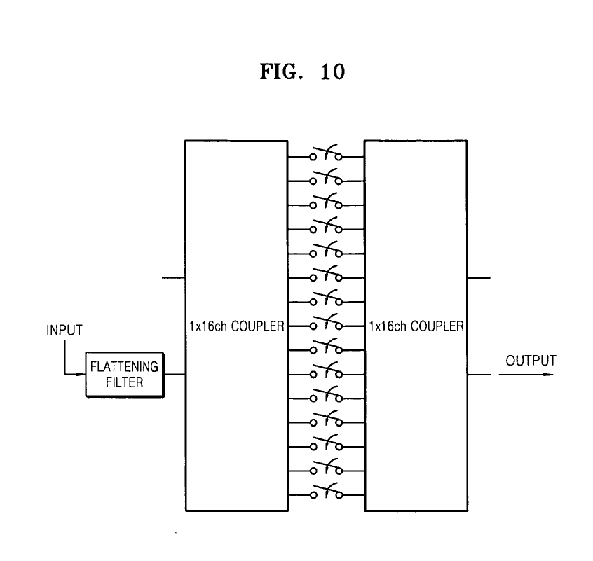

FIG. 8 is a graph illustrating a transmission spectrum of a flattening filter compensating for a non-uniform spectrum of a light source using fused couplers according to the present invention.

An output spectrum of a flattening filter formed using two fused couplers is compared with an output spectrum of an SLED. Central wavelengths and wavelength periods of the two fused couplers constituting the flattening filter can be optimized to effectively reduce a power difference of each channel of the SLED.

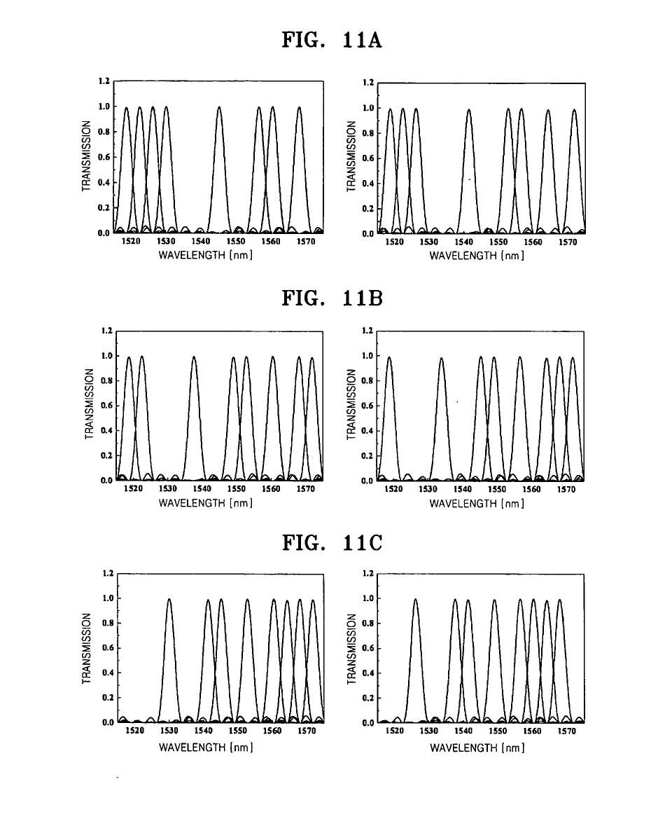

FIG. 9 is a graph illustrating a transmission spectrum of a structure into which a flattening filter compensating for a non-uniform spectrum of a light source using two fused couplers and a 16-channel demultiplexer are integrated according to the present invention.

Demultiplexing is achieved through each of 16 channels, and output powers from the 16 channels are different. Thus, an encoder and/or decoder according to the present invention can compensate for a non-uniform spectrum of the light source.

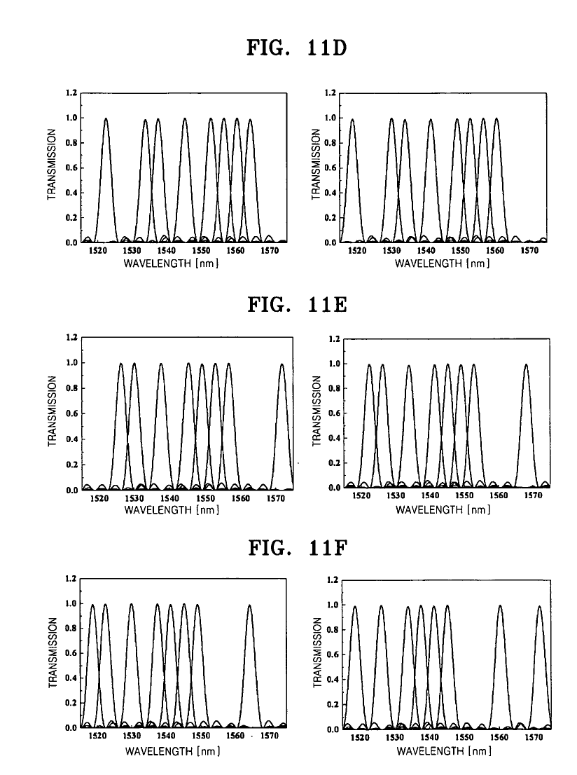

FIG. 10 is a view illustrating a structure of an encoder and/or decoder for an OCDMA according to the present invention.

A 16-channel demultiplexer constituted using 15 fused couplers can be connected to a flattening filter constituted using two fused couplers, and the 16-channel demultiplexer can be connected in an opposite direction so as to realize an encoder. Also, a decoder has the same structure as the encoder except the flattening filter.

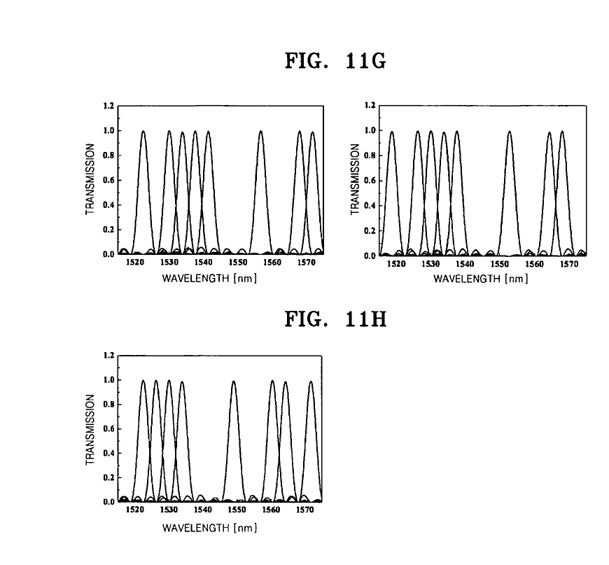

FIGS. 11A through 11H are graphs illustrating spectrums of PN codes realized in a structure of an encoder and/or decoder for an OCDMA according to the present invention.

Spectrums of modified PN codes using an encoder and/or decoder excluding a flattening filter unlike the encoder and/or decoder shown in FIG. 10 are shown.

FIG. 11A illustrates spectrums of modified PN codes [1111000100110100] and [1110001001101010] realized in the structure of the encoder and/or decoder shown in FIG. 10.

FIG. 11B illustrates spectrums of modified PN codes [1100010011010110] and [1000100110101110] realized in the structure of the encoder and/or decoder shown in FIG. 10.

FIG. 11C illustrates spectrums of modified PN codes [0001001101011110] and [0010011010111100] realized in the structure of the encoder and/or decoder shown in FIG. 10.

FIG. 11D illustrates spectrums of modified PN codes [0100110101111000] and [1001101011110000] realized in the structure of the encoder and/or decoder shown in FIG. 10.

FIG.11E illustrates spectrums of modified PN codes [0011010111100010] and [0110101111000100] realized in the structure of the encoder and/or decoder shown in FIG. 10.

FIG. 11F illustrates spectrums of modified PN codes [1101011110001000] and [1010111100010010] realized in the structure of the encoder and/or decoder shown in FIG. 10.

FIG. 11G illustrates spectrums of modified PN codes [0101111000100110] and [1011110001001100] realized in the structure of the encoder and/or decoder shown in FIG. 10.

FIG. 11H illustrates a spectrum of a modified PN code [0111100010011010] realized in the structure of the encoder and/or decoder shown in FIG. 10.

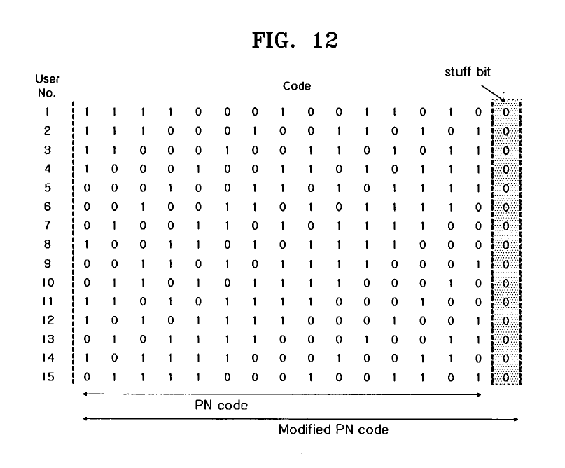

FIG. 12 is a view illustrating modified PN codes having a code length of 15.

The modified PN codes shown in FIG. 12 has the code length of 15.

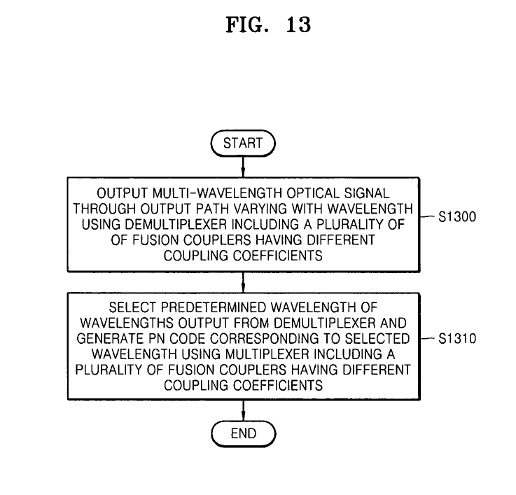

FIG. 13 is a flowchart of a process of operating an encoder and/or decoder for an OCDMA according to the present invention.

In operation S1300, a demultiplexer including a plurality of fused couplers having different coupling coefficients outputs multi-wavelength optical signals through paths varying with a wavelength.

In operation S1310, a multiplexer including a plurality of fused couplers having different coupling coefficients selects the signal of predetermined wavelengths out of output signals from the demultiplexer and generates a PN code corresponding to the selected wavelengths.

As described above, in an encoder and/or decoder for an OCDMA based on a fused coupler according to the present invention, a transmission rate or a number of channels is not limited by a delay. Also, the encoder and/or decoder can include a flattening filter to compensate for a non-uniform spectrum of a light source.

In addition, the encoder and/or decoder are hardly affected by a temperature and can be manufactured at a low cost.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An encoder and/or decoder for an OCDMA (optical code division multiple access), comprising:
a demultiplexer outputting multi-wavelength optical signals through paths varying with a wavelength using a plurality of first fused couplers having different coupling coefficients; and
a multiplexer selecting the signal of predetermined wavelengths out of output signals from the demultiplexer and generating a PN code corresponding to the selected wavelengths using a plurality of second fused couplers symmetric to the plurality of first fused couplers.

2. The encoder and/or decoder of claim 1, wherein the first and second fused couplers comprise integrated portions formed by touching, twisting, heating, and tensing cores of predetermined portions of two optical fibers.

3. The encoder and/or decoder of claim 1, further comprising:
a first integrated part generated by touching, twisting, heating, and tensing cores of predetermined first and second points of a first fiber receiving a multi-wavelength optical signal and outputting the multi-wavelength optical signal to the demultiplexer and having a coupling coefficient M; and
a second integrated part generated by touching, twisting, heating, and tensing cores of a third point between the first and second points and a predetermined point of a second fiber and having a coupling coefficient N.

4. An encoding and/or decoding method for an OCDMA, comprising:
outputting multi-wavelength optical signals through paths varying with a wavelength using a plurality of first fused couplers having different coupling coefficients; and
selecting the signals of predetermined wavelengths out of output signals using a plurality of second fused couplers symmetric to the plurality of first fused couplers and generating a PN code corresponding to the selected wavelengths.

5. The encoding and/or decoding method of claim 4, wherein the first and second fused couplers are formed by touching, twisting, heating, and tensing cores of predetermined portions of two optical fibers.

6. The encoding and/or decoding method of claim 4, before outputting the multi-wavelength optical signal through the path varying with the wavelength using the plurality of first fused couplers having the different coupling coefficients, further comprising compensating for a power difference of a predetermined multi-wavelength optical signal output through each channel to generate a flattened multi-wavelength optical signal.
